(19) United States
(12) Patent Application Publication
(10) Pub. No.: US 2011/0223408 A1
(43) Pub. Date: Sep. 15, 2011

(54) GRANULATED POWDER AND METHOD FOR PRODUCING GRANULATED POWDER

(75) Inventor: Takeshi KADOMURA, Iwata (JP)

(73) Assignee: SEIKO EPSON CORPORATION, Tokyo (JP)

(21) Appl. No.: 13/045,002

(22) Filed: Mar. 10, 2011

(30) Foreign Application Priority Data
Mar. 11, 2010 (JP) 2010-055147

(51) Int. Cl. B32B 5/16; B05D 7/14; B05D 1/02; C08L 29/04; C08L 91/08; C08K 5/1535; C08K 5/053; C08K 5/17

(52) U.S. Cl. 428/221; 427/216; 524/557; 524/65; 524/113; 524/388; 524/251; 524/247

(57) ABSTRACT

A granulated powder comprises a plurality of metal particles and an organic binder. It is obtainable by binding a plurality of metal particles to one another by the organic binder. The organic binder contains polyvinyl alcohol or a derivative thereof, a wax, and a nonionic surfactant. The total amount of the wax and the nonionic surfactant is preferably from 0.01 to 1 part by weight based on 100 parts by weight of the metal particles. Further, the organic binder preferably further contains a polyol and an organic amine.

### BACKGROUND

1. Technical Field

The present invention relates to a granulated powder and a method for producing a granulated powder.

2. Related Art

As a method for powder metallurgy, a powder compacting method is known. In this method, a mixture of a metal powder and an organic binder is filled in a given molding die, followed by compaction, thereby obtaining a green body in a given shape. The obtained green body is subjected to a degreasing treatment of removing the organic binder and a firing treatment of sintering the metal powder, thereby forming a metal sintered body. Such a technique is an exemplary powder metallurgy technique, and a large amount of a metal sintered body in a complicated shape can be produced according to the shape of the molding die. Therefore, such a technique has been widely spread in many industrial fields.

In the powder compacting method, first, it is necessary to fill a metal powder in a molding die as tightly as possible. This is because any space in the molding die will remain in the resulting green body as a hole, resulting in poor density of the resulting metal sintered body.

However, as the metal powder, a fine powder having an average particle diameter of 10 μm or less is sometimes used. Such a fine powder has low fluidity, and therefore is poor for completely filling a molding die. Therefore, a mixture of a metal powder and an organic binder is granulated into particles having a larger particle size to improve the fluidity thereof. When the mixture is granulated, a plurality of particles in the metal powder are bound to one another by the organic binder, thereby forming a granulated powder having a larger particle size. The granulated powder has higher fluidity than the metal powder, and therefore is excellent at filling a molding die, and thus, a dense green body and a dense sintered body can be produced.

For example, JP-A-2005-154847 discloses a method for obtaining a sintered body by powder compacting a granulated powder of a metal powder and firing the resulting green body at a high temperature of 1200° C. or higher.

However, a firing furnace which can be used at a temperature of 1200° C. or higher needs a special heat resistant structure, and therefore is expensive, and also has a high running cost.

On the other hand, if the firing temperature is decreased, the density of the resulting sintered body is decreased, and a problem arises in that the sintered body has a poor mechanical property.

### SUMMARY

An advantage of some aspects of the invention is to provide a granulated powder which is favorably sintered even if it is fired at a relatively low temperature and is capable of producing a sintered body having a high density, and also to provide a method for producing a granulated powder capable of easily producing such a granulated powder.

In accordance with an aspect of the invention, there is provided a granulated powder comprising a plurality of metal particles bound to one another by an organic binder, wherein the organic binder contains polyvinyl alcohol or a derivative thereof, a wax, and a nonionic surfactant.

According to this configuration, a granulated powder which is favorably sintered even if it is fired at a relatively low temperature and is capable of producing a sintered body having a high density can be obtained.

In accordance with the aspect of the invention, a total amount of the wax and the nonionic surfactant is preferably from 0.01 to 1 part by weight based on 100 parts by weight of the metal particles.

According to this configuration, a sintered body having a particularly high sintering density can be obtained.

In accordance with the aspect of the invention, the wax is preferably a mineral wax, a petroleum wax, or a modified wax thereof.

According to this configuration, the fluidity of the particles of the granulated powder can be increased, and therefore, a sintered body having a high sintering density can be produced therefrom.

In accordance with the aspect of the invention, the mineral wax is preferably montan wax or a derivative thereof.

According to this configuration, the organic binder has optimal plasticity, and together with the excellent fluidity imparted to the particles of the granulated powder, a sintered body having a higher sintering density can be produced.

In accordance with the aspect of the invention, the petroleum wax is preferably paraffin wax, microcrystalline wax, or a derivative of one of these.

According to this configuration, the densification of the granulated powder is further enhanced.

In accordance with the aspect of the invention, the nonionic surfactant is preferably a sorbitan fatty acid ester.

The sorbitan fatty acid ester is useful because it has high biological safety and can further increase the affinity between the metal particles and the wax.

In accordance with the aspect of the invention, the organic binder preferably further contains a polyol.

According to this configuration, the granulated powder is further densified.

In accordance with the aspect of the invention, the polyol is preferably glycerin.

Among polyols, glycerin has a relatively low molecular weight and also has a high hydroxyl group content, and therefore easily enters between the molecules of polyethylene glycol. Moreover, glycerin contains many sites which contribute to hydrogen bond formation, and therefore contributes to the densification of the granulated powder. Further, glycerin has a moderate viscosity, and therefore can further increase the binding property of the metal particles at the time of granulation and the shape retaining property of the green body.

In accordance with the aspect of the invention, an amount of the polyol is preferably 0.01 parts by weight or more but less than 0.3 parts by weight based on 100 parts by weight of the metal particles.

According to this configuration, the granulated powder can be particularly dense, and therefore a sintered body having a high density can be obtained. Further, the occurrence of spring back (i.e. the result of accumulation of stress in the green body during powder compacting and relief of the accumulated stress after completion of compaction accompanied by deformation) can be prevented.

In accordance with the aspect of the invention, the organic binder preferably further contains an organic amine.

According to this configuration, the organic amine is spontaneously adsorbed onto the surfaces of the metal particles to reduce the interparticle friction, thereby enhancing the densification of the granulated powder. In addition to this, the organic amine adsorbed onto the surfaces of the particles reduces the chance of contact between the particles and the outside air, and therefore, the weather resistance of the particles can be increased.

In accordance with the aspect of the invention, the organic amine is preferably at least one of an alkylamine, a cycloalkylamine, and an alkanolamine (including derivatives of these).

According to this configuration, the densification of the granulated powder is further enhanced.

In accordance with the aspect of the invention, an amount of the organic amine is preferably from 30 to 200% by weight based on the total amount of the wax and the nonionic surfactant.

According to this configuration, the balance between the organic amine, and the wax and the nonionic surfactant is optimized.

In accordance with the aspect of the invention, each of the plurality of the metal particles is preferably covered with a coating layer which comprises the organic amine.

According to this configuration, a granulated powder which is favorably sintered even if it is fired at a relatively low temperature and is capable of producing a sintered body having a high density can be easily produced.

In accordance with another aspect of the invention, there is provided a method for producing a granulated powder, comprising providing a metal powder, while tumbling or flowing the metal powder, simultaneously supplying a solution of an organic binder to the metal powder, wherein the organic binder contains polyvinyl alcohol, a wax, and a nonionic surfactant, thereby, granulating the metal powder.

According to this configuration, since the right amount of the binder solution is supplied uniformly to the metal particles, the shape and size of the granulated powder can be made uniform. As a result, a granulated powder having a uniform particle size distribution can be obtained.

In accordance with the aspect of the invention, the solution of the organic binder is preferably supplied by spraying.

According to this configuration, since the right amount of the binder solution is supplied uniformly to the metal particles, the shape and size of the granulated powder can be made uniform. As a result, a granulated powder having a uniform particle size distribution can be obtained.

### BRIEF DESCRIPTION OF THE DRAWINGS

The invention will be described with reference to the accompanying drawings, wherein like numbers reference like elements.

FIGS. 1A and 1B are schematic views showing a structure of a tumbling granulator to be used in a method for producing a granulated powder according to the invention.

FIG. 2 is a graph showing the distribution of molded bodies (green bodies) obtained using the granulated powders obtained in the respective Examples and Comparative Example 1 with the horizontal axis representing the total addition amount of a wax and a nonionic surfactant, and the vertical axis representing a molding density.

FIG. 3 is a graph showing the distribution of molded bodies(green bodies) obtained using the granulated powders obtained in the respective Examples and Comparative Example 1 with the horizontal axis representing the addition amount of a polyol and the vertical axis representing the molding density.

### DESCRIPTION OF EXEMPLARY EMBODIMENTS

Hereinafter, the granulated powder and the method for producing a granulated powder according to the invention will be described in detail by way of preferred embodiments with reference to the accompanying drawings.

The granulated powder according to the invention contains a metal powder and an organic binder, and is obtained by binding a plurality of metal particles in the metal powder by the organic binder.

Further, the organic binder to be used in the invention contains polyvinyl alcohol or a derivative thereof, a wax, and a nonionic surfactant.

Such a granulated powder is favorably sintered even if it is fired at a relatively low temperature and is capable of producing a sintered body having a high density. Therefore, it has an advantage that one can use a firing furnace which does not have a special heat resistant structure, is inexpensive, and has low running cost.

Hereinafter, the granulated powder according to the invention will be described in detail.

### Metal Particles (Metal Powder)

The metal particles used are not particularly limited. Examples thereof include particles of Mg, Al, Ti, V, Cr, Mn, Fe, Co, Ni, Cu, Zn, Y, Zr, Nb, Mo, Pd, Ag, In, Sn, Ta, W, and alloys thereof.

Among these, particles of any of a variety of Fe-based alloys such as stainless steel, dies steel, high-speed tool steel, low-carbon steel, Fe—Ni alloy, and Fe—Ni—Co alloy are preferably used. These may be provided in the form of a metal powder. Since such an Fe-based alloy has an excellent mechanical property, a sintered body obtained using this Fe-based alloy powder has an excellent mechanical property and can be used in a wide range of applications.

Examples of the stainless steel include SUS 304, SUS 316, SUS 317, SUS 329, SUS 410, SUS 430, SUS 440, and SUS 630.

Further, the average particle diameter of the metal particles is preferably from 1 to 30 μm, more preferably from 3 to 20 μm, further more preferably from 3 to 10 μm. The metal particles having such a particle diameter is capable of producing a sufficiently dense sintered body while avoiding a decrease in the compressibility at the time of compacting.

Incidentally, if the average particle diameter is less than the above lower limit, the metal powder is liable to aggregate and the compressibility at the time of compacting may be significantly decreased. On the other hand, if the average particle diameter exceeds the above upper limit, the space between the particles of the powder may be too large, and the densification of the finally obtained sintered body may be insufficient.

Further, the tap density of the metal powder is, in the case of, for example, an Fe-based alloy powder, preferably 3.5 g/cm³ or more, more preferably 3.8 g/cm³ or more. When the metal powder has a high tap density as described above, at the time of obtaining the granulated powder, the interparticle filling property is particularly increased. Therefore, a particularly dense sintered body can be obtained using the granulated powder.

Further, the specific surface area of the metal powder is not particularly limited, however, it is preferably 0.15 m²/g or more, more preferably 0.2 m²/g or more, further more preferably 0.3 m²/g or more. When the metal powder has a large specific surface area as described above, the surface activity (surface energy) is increased, and therefore, sintering can be easily performed even if lower energy is applied. Accordingly, sintering can be achieved in a shorter time when the green body is sintered. As a result, a dense sintered body can be obtained even if the green body is fired at a low temperature.

Such a metal powder may be produced by any method. A metal powder produced by, for example, an atomization method (a water atomization method, a gas atomization method, a high-speed spinning water atomization method, etc.), a reduction method, a carbonyl method, a pulverization method can be used.

In particular, a metal powder produced by an atomization method is preferably used. By the atomization method, it is possible to efficiently produce metal particles having an extremely small average particle diameter as described above. Further, it is possible to obtain metal particles having a uniform particle diameter and a small variation in particle diameter. Accordingly, by using such a metal powder, air holes can be reliably prevented from being generated in the sintered body, and the density can be improved.

Further, the metal particles produced by an atomization method have a spherical shape relatively close to a true sphere, and therefore have excellent dispersibility and fluidity in the binder. Therefore, when the granulated powder is filled in a molding die to effect compacting, the extent of filling can be increased, and a dense sintered body can be obtained.

### Organic Binder

According to the invention, as described above, the organic binder contains polyvinyl alcohol (PVA) or a derivative thereof, a wax, and a nonionic surfactant.

In existing granulated powder, a high apparent density could not be realized. It is considered that this is because the distance between particles of a metal powder could not be sufficiently reduced. In particular, when the metal particle diameter was small, the metal powder was bulky, and the above tendency was more prominent. Such a granulated powder having a low apparent density had the problem that a sufficient sintering density could not be obtained unless it was sintered at a high temperature.

On the other hand, by using the above-mentioned organic binder, when the metal particle and the organic binder are mixed and the resulting mixture is granulated to form a granulated powder, the assembling property of the metal particles is increased, and a granulated powder having a high apparent density can be obtained.

In the thus densified granulated powder, the distance between metal particles is sufficiently reduced, and therefore, at the time of performing degreasing and firing, sintering is completed at a lower temperature in a shorter time. Therefore, a firing furnace which does not have a special heat resistant structure, is relatively inexpensive, and has low running cost can be used, and a sintered body having a high density can be efficiently produced.

The reason why the granulated powder according to the invention exhibits the above-mentioned effect is considered to be as follows.

First, polyvinyl alcohol is soluble in water, and has high affinity for metal particles. It is considered that this is because polyvinyl alcohol has a lot of hydroxyl groups in its molecular chain, which brings about an interaction derived from a hydrogen bond with hydroxyl groups exposed on the surfaces of the metal particles. Due to this interaction, it is considered that the distance between the metal particles is reduced, and a densification of the granulated powder and moreover, a densification of the sintered body are enhanced.

Further, polyvinyl alcohol is promptly decomposed at a relatively low temperature, and therefore, hardly functions as an inhibitory factor for sintering. Due to this, it is considered that even if a green body obtained by compacting the granulated powder according to the invention is fired at a low temperature, the organic binder hardly remains between the particles of the metal powder, and sintering can be achieved at a lower temperature in a shorter time.

On the other hand, polyvinyl alcohol has a somewhat low plasticity, and therefore hardly contributes to the rearrangement of the granulated powder or the shape retaining property of the green body.

Meanwhile, a wax has favorable plasticity and therefore can impart plasticity to the organic binder. Accordingly, the rearrangement of the granulated powder, and the shape retaining property and the releasing property of the green body can be increased.

Further, it is considered that the wax reduces the friction on the surfaces of the particles of the metal powder and can increase the fluidity of the particles of the granulated powder. However, the wax is mainly composed of a saturated hydrocarbon and is generally not soluble in water and has low affinity for the metal powder. On the other hand, the nonionic surfactant is considered to function to increase the affinity between the wax and the metal particles by interposing therebetween. As a result, the wax can be distributed so as to cover the surfaces of the metal particles, and the fluidity of the particles of the granulated powder, and the shape retaining property and the releasing property of the green body are considered to be increased.

Further, it is considered that the nonionic surfactant also has the function of increasing the affinity between polyvinyl alcohol or a derivative thereof and the wax. For example, since the nonionic surfactant has a hydroxyl group in its molecular chain, it is considered that the nonionic surfactant enters between the molecules of polyvinyl alcohol and contributes to the reduction of the distance between the molecules of polyvinyl alcohol. Due to this, the respective components of the organic binder can be uniformly mixed regardless of the mixing ratio thereof, and it is considered that the nonionic surfactant increases the dispersibility of the metal particles and the organic binder and also contributes to the reduction of the distance between the metal particles.

For the above reasons, the granulated powder according to the invention becomes dense and has a high apparent density. Specifically, the ratio of the apparent density (g/cm³) of the granulated powder according to the invention to the true density (g/cm³) of the metal particles is preferably expected to be from 20% to 50%. Such a granulated powder is favorably sintered even if it is fired at a relatively low temperature and is capable of producing a sintered body having a high density. Therefore, it has an advantage that a firing furnace which does not have a special heat resistant structure, is inexpensive, and has low running cost can be used.

Incidentally, as the granulated powder is densified to such an extent that the ratio of the apparent density falls within the above range, the shrinkage ratio at the time of sintering is decreased by that much. As a result, the dimension of the sintered body hardly deviates from a target value, and the dimensional accuracy of the sintered body can be increased. That is, according to the invention, a sintered body having a high dimensional accuracy can be obtained.

As the polyvinyl alcohol or a derivative thereof, one having a weight-average molecular weight of from about 2000 to 200000 is preferably used, and one having a weight-average molecular weight of from about 5000 to 150000 is more preferably used. Polyvinyl alcohol having such a weight-average molecular weight is most suitable as the organic binder in terms of viscosity and ability to thermally decompose. That is, such polyvinyl alcohol can bind the metal particles at the time of granulation and can disintegrate at the time of compacting and the shape retaining property of the green body after compacting to a high level. As a result, by using the granulated powder according to the invention, a sintered body having a high density and excellent dimensional accuracy can be obtained.

Incidentally, the derivative of polyvinyl alcohol may refer to one obtained by substituting a hydrogen atom attached to a carbon atom with any of various functional groups, and examples of the functional group include an alkyl group, a silyl group, and an acrylate group.

On the other hand, examples of the wax include natural waxes and synthetic waxes.

Examples of the natural waxes include vegetable waxes such as candelilla wax, carnauba wax, rice wax, Japan wax, and jojoba wax; animal waxes such as bees wax, lanolin, and whale wax; mineral waxes such as montan wax, ozokerite, and ceresin; and petroleum waxes such as paraffin wax, microcrystalline wax, and petrolactam, and these can be used alone or in combination of two or more.

Further, examples of the synthetic waxes include synthetic hydrocarbons such as polyethylene wax; modified waxes such as montan wax derivatives, paraffin wax derivatives, and microcrystalline wax derivatives; hydrogenated waxes such as hydrogenated castor oil and hydrogenated castor oil derivatives; fatty acids such as 12-hydroxystearic acid; acid amides such as stearic acid amide; and esters such as phthalic anhydride imide, and these can be used alone or in combination of two or more.

In the invention, among the above waxes, a mineral wax, a petroleum wax, or a modified wax thereof is preferably used. By using such a wax, the fluidity of the particles of the granulated powder can be increased, and therefore, a sintered body having a high sintering density can be produced in the end.

Further, particularly, by using montan wax or a derivative thereof as the mineral wax or a modification thereof, the organic binder has optimal plasticity, and together with the excellent fluidity imparted to the particles of the granulated powder, a sintered body having a higher sintering density can be produced.

Further, particularly, by using paraffin wax, microcrystalline wax or a derivative thereof as the petroleum wax or a modification thereof, the organic binder has also optimal plasticity, and together with the excellent fluidity imparted to the particles of the granulated powder, a sintered body having a higher sintering density can be produced.

Further, examples of the nonionic surfactant include ester-type nonionic surfactants such as glycerin fatty acid esters, sorbitan fatty acid esters, and sucrose fatty acid esters; ether-type nonionic surfactants such as polyoxyethylene alkyl ethers, polyoxyethylene alkylphenyl ethers, and polyoxyethylene polyoxypropylene glycol; ester ether-type nonionic surfactants obtained by combining the ester-type and ether-type nonionic surfactants such as polyoxyethylene sorbitan fatty acid esters; and fatty acid alkanolamide-type nonionic surfactants, and these can be used alone or in combination of two or more.

Among these, a sorbitan fatty acid ester is particularly preferably used. The sorbitan fatty acid ester is useful because sorbitan is one of the saccharides and therefore the sorbitan fatty acid ester has high biological safety and can further increase the affinity between the metal particles and the wax.

The total amount of the wax and the nonionic surfactant is preferably from 0.01 to 1 part by weight, more preferably from 0.02 to 0.5 parts by weight based on 100 parts by weight of the metal particles. By adding the wax and the nonionic surfactant in such an amount, a sintered body having a particularly high sintering density can be obtained.

Further, the weight ratio of the wax to that of the nonionic surfactant is preferably from 1:9 to 8:2, more preferably from 4:6 to 8:2. According to this configuration, the balance between the wax and the nonionic surfactant is optimized, and the above-mentioned effect becomes more prominent.

The organic binder to be used in the invention preferably contains a polyol, an organic amine, or the like other than the above-mentioned components.

By adding a polyol to the organic binder, the granulated powder can be further densified.

In a method of producing the afore-mentioned granulated powder, a first step may comprise uniformly mixing, polyvinyl alcohol or a derivative thereof and a polyol with each other, regardless of the mixing ratio of both components. This is because the hydroxyl groups of both molecules are attracted to each other by a hydrogen bond so that the distance between molecules is reduced. It is considered that in particular, the molecule of the polyol enters between the molecules of polyvinyl alcohol and contributes to the reduction of the distance between the molecules of polyvinyl alcohol. Moreover, the above-mentioned organic binder is promptly decomposed at a relatively low temperature, and therefore, hardly functions as an inhibitory factor for sintering. Due to this, it is considered that the green body obtained by compacting the granulated powder according to the invention is sintered at a lower temperature in a shorter time.

Further, it is considered that these organic binder molecules are attracted also to the particles of the metal particles by a hydrogen bond. This is because a hydroxyl group is exposed on the surfaces of the particles of the metal powder, and therefore a hydrogen bond is formed between this hydroxyl group and the hydroxyl group of the organic binder molecule. As a result, it is considered that the distance between the metal particles is reduced, so that the granulated powder is densified, and also the resulting sintered body is densified.

Examples of the polyol include ethylene glycol, propylene glycol, butylene glycol, hexylene glycol, pentane diol, hexane diol, heptane diol, diethylene glycol, dipropylene glycol, and glycerin, and these polyols can be used alone or in combination of two or more.

Among these, glycerin is particularly preferred as the polyol. Among polyols, glycerin has a relatively small molecular weight and also has a high hydroxyl group content. Therefore, glycerin easily enters between the molecules of polyethylene glycol, and also the site which contributes to the above-mentioned hydrogen bond is increased, and therefore the granulated powder is further densified. Further, glycerin has a moderate viscosity, and therefore can further increase the binding property of the metal powder at the time of granulation and the shape retaining property of the green body.

Such a polyol is added in an amount of preferably from 0.01 to 0.3 parts by weight, more preferably from 0.01 to 0.2 parts by weight based on 100 parts by weight of the metal powder. By adding the polyol in such an amount, the granulated powder can be particularly densified.

If the addition amount of the polyol is less than the above-mentioned lower limit, the density of the granulated powder and also the density of the sintered body may be decreased. If the addition amount of the polyol exceeds the above-mentioned upper limit, the density of the granulated powder may also be decreased, and a phenomenon, a so-called “spring back” in which stress is accumulated in the green body during powder compacting and the residual stress after completion of compacting is relieved accompanied by deformation is increased. Therefore, the dimensional accuracy of the sintered body may be decreased or cracking or the like may occur.

Further, the amount of the polyol is preferably from 20 to 150% by weight, more preferably from 30 to 120% by weight based on the total amount of the wax and the nonionic surfactant. According to this configuration, the balance between the polyol, and the wax and the nonionic surfactant is optimized.

Further, the organic binder preferably contains an organic amine or a derivative thereof other than the above-mentioned components. By incorporating an organic amine or a derivative thereof in the organic binder, the fluidity and weather resistance of the metal powder can be increased. This organic amine contains an amino group in each molecule, and this amino group is spontaneously adsorbed onto the surfaces of the metal particles, and therefore, the interparticle friction can be reduced. As a result, the fluidity of a metal powder comprising said metal particles is increased and the distance between the particles is reduced. In this manner, the organic amine contributes to the densification of the granulated powder. In addition, the organic amine adsorbed onto the surfaces of the particles reduces the chance of contact between the particles and the outside air, and therefore, the particles can be protected from oxygen, moisture, and the like, and the weather resistance of the particles is increased.

Incidentally, the adsorption of the amino group onto the surfaces of the particles is considered to be due to an interaction between the lone pair of electrons of the amino group which is a polar group and an adsorption site of the surfaces of the metal particles.

Examples of such an organic amine include alkylamines, cycloalkylamines, alkanolamines, allylamines, arylamines, alkoxyamines, and derivatives of the afore-mentioned. Among these, particularly, at least one of alkylamines, cycloalkylamines, alkanolamines, and derivatives thereof is preferably used. These amines contribute to further densification of the granulated powder.

Examples of the alkylamine include monoalkylamines such as n-hexylamine, n-heptylamine, n-octylamine (normal-octylamine), and 2-ethylhexylamine; dialkylamines such as diisobutylamine; and trialkylamines such as diisopropylethylamine.

Examples of the cycloalkylamine include cyclohexylamine and dicyclohexylamine.

Examples of the alkanolamine include monoethanolamine, diethanolamine, triethanolamine, monopropanolamine, dipropanolamine, tripropanolamine, N,N-dimethylethanolamine, N,N-diethylethanolamine, N-aminoethylethanolamine, N-methylethanolamine, and N-methyldiethanolamine.

The derivative of such an organic amine is not particularly limited. Preferably, it is a nitrite of an organic amine, a carboxylate of an organic amine, a chromate of an organic amine, or an acetate of an organic amine.

Such an organic amine is preferably added in an amount of from 0.001 to 5 parts by weight, more preferably from 0.005 to 1 part by weight based on 100 parts by weight of the metal particles. By adding the organic amine in such an amount, the granulated powder can be further densified and the weather resistance of the granulated powder can be further increased.

Further, the amount of the organic amine is preferably from 30 to 200% by weight, more preferably from 50 to 150% by weight based on the total amount of the wax and the nonionic surfactant. According to this configuration, the balance between the organic amine, and the wax and the nonionic surfactant is optimized.

The metal particles to be used in the invention are preferably covered with a coating layer composed of the above-mentioned organic amine. According to this configuration, the chance of contact between the metal particles and the outside air can be more reliably reduced, and therefore, the weather resistance of the particles can be particularly increased.

In this case, the average thickness of the coating layer is preferably from 3 nm to 3 μm, more preferably from 10 nm to 1 μm.

The organic binder may contain for example, polyvinylpyrrolidone (PVP), stearic acid, ethylenebisstearamide, an ethylene-vinyl copolymer, sodium alginate, agar, gum Arabic, a resin, or sucrose other than the above-mentioned components.

Further, to the organic binder, an additive such as a phthalic acid ester (such as DOP, DEP, or DBP), an adipic acid ester, a trimellitic acid ester, or a sebacic acid ester may be added as needed.

Further, as the additive, an antioxidant, a degreasing accelerator, a surfactant, or the like may be added other than the above-mentioned components.

The total content of the polyvinyl alcohol or the derivative thereof, the wax, and the nonionic surfactant in the organic binder is preferably 90% by weight or more, more preferably 95% by weight or more based on the total weight of the binder. By allowing the content thereof to fall within the above range, the above-mentioned action and effect of the organic binder are reliably exhibited and a granulated powder having a sufficiently high density can be obtained.

### Granulated Powder

The granulated powder according to the invention contains the above-mentioned metal particles and organic binder. The content of the organic binder in the granulated powder is preferably from 0.1 to 20% by weight, more preferably from 0.3 to 10% by weight based on the weight of the granulated powder. By allowing the content of the organic binder to fall within the above range, the binding between the metal particles and the sufficient densification of the granulated powder can be achieved. Further, by using such a granulated powder, the disintegrating property at the time of compacting and the shape retaining property of the green body after compacting can be improved. As a result, a sintered body having a high density and excellent dimensional accuracy can be obtained.

In the granulated powder according to the invention, as described above, the ratio of the apparent density of the granulated powder to the true density of the metal particles is expected to be from 20% to 50%. The apparent density of the granulated powder refers to the mass:volume ratio of the granulated powder in a state where the powder is naturally filled, and can be determined according to Test Method for Apparent Density of Metal Powders specified in JIS Z 2504. On the other hand, the true density of the metal particles refers to a true density of the metal material constituting the metal particles.

By using the organic binder as described above, the densification of the granulated powder is achieved, and the granulated powder in which the ratio of the apparent density to the true density of the metal powder falls within the above range can be obtained. Such a granulated powder is capable of forming a green body having a high molding density when it is molded, and also is capable of forming a sintered body having a high sintering density. Further, the shrinkage ratio at the time of sintering can be reduced, and therefore, the dimensional accuracy of the sintered body can be increased.

The ratio of the apparent density of the granulated powder according to the invention to the true density of the metal particles is more preferably from 25% to 45%, further more preferably from 30% to 40%.

Further, the shape of each particle of the granulated powder according to the invention greatly affects the fluidity and the filling property. From this viewpoint, the shape of each particle of the granulated powder is preferably a shape close to a true sphere.

Further, not only the above-mentioned metal particles, but also the granulated powder according to the invention is preferably covered with a coating layer composed of the above-mentioned organic amine. According to this configuration, the chance of contact between the metal particles and the outside air can be more reliably reduced, and therefore, the weather resistance of the particles can be particularly increased. As a result, a sintered body having a higher density can be obtained.

In this case, the average thickness of the coating layer is preferably from 3 nm to 3 μm, more preferably from 10 nm to 1 μm.

### Method for Producing Granulated Powder

Subsequently, an embodiment of the method for producing a granulated powder according to the invention will be described.

Hereinafter, prior to the description of the method for producing a granulated powder, a granulator to be used in this production method will be described.

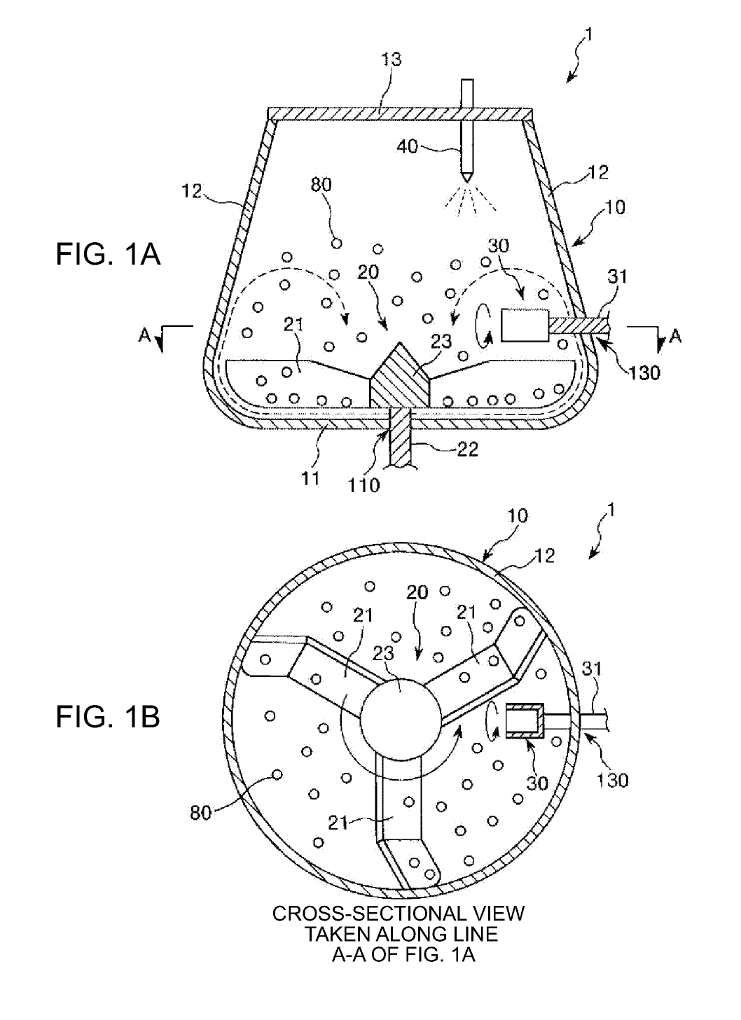

FIGS. 1A and 1B are schematic views showing a structure of a tumbling granulator to be used in the method for producing a granulated powder according to the invention: FIG. 1A is a vertical cross-sectional view of the tumbling granulator; and FIG. 1B is a cross-sectional view taken along the line A-A of FIG. 1A.

A tumbling granulator 1 is provided with a treatment vessel 10 for performing granulation, a blade 20 and a cross screw 30 installed in the treatment vessel 10, and a spray nozzle 40.

As shown in FIG. 1A, the treatment vessel 10 has a bottom portion 11 and a side wall portion 12 vertically provided from the bottom portion 11. The side wall portion 12 has a conical shape (for example, a circular truncated cone tube shape) in which the inner and outer diameters gradually increase from the top to the bottom. Since the treatment vessel 10 (side wall portion 12) has such a shape, an air current can be formed in the treatment vessel 10 such that a powder comprising metal particles is picked up by the blade 20 at the outer periphery of the treatment vessel 10 falls at the center of the treatment vessel 10. As a result, the powder can be uniformly treated, and therefore, a granulated powder having a sharp particle size distribution can be efficiently produced.

Further, the treatment vessel 10 has an opening on the top, and a lid 13 is attached thereto so as to close the opening.

The blade 20 has a base portion 23, and three rotary vanes 21, which are fixed to the base portion 23 at one end thereof and are arranged radially at approximately equal intervals.

Further, in the center of the bottom portion 11 of the treatment vessel 10, a through-hole 110 is provided, and a rotary drive shaft 22 is inserted into this through-hole 110.

The upper end of the rotary drive shaft 22 is fixed to the base portion 23 and the lower end thereof is connected to a rotary driving source (not shown). Then, the rotary drive shaft 22 is rotationally driven in the forward or reverse directions by this rotary driving source, thereby rotating the blade 20.

Further, each of the rotary vanes 21 is fixed inclined with respect to the rotary drive shaft 22 such that it is inclined downwardly toward the front side in the rotating direction of the blade 20. According to this configuration, as the blade 20 rotates, the powder can be effectively picked up and an air current as described above can be formed.

In the side wall portion 12 of the treatment vessel 10, a through-hole 130 is provided, and a rotary drive shaft 31 is inserted into this through-hole 130.

One end of the rotary drive shaft 31 is fixed to the cross screw 30, and the other end thereof is connected to a rotary driving source (not shown). Then, the rotary drive shaft 31 is rotationally driven in the forward reverse directions by this rotary driving source, thereby rotating the cross screw 30.

The spray nozzle 40 is provided such that it pierces the lid 13 attached to the treatment vessel 10, and a supply port is located in the treatment vessel 10. According to this configuration, a solvent can be sprayed into the treatment vessel 10. By spraying a solvent from the spray nozzle 40, a descending air current is formed in the vicinity of the spray nozzle 40.

Here, the operation of the tumbling granulator 1 as described above, that is, the method for producing a granulated powder using the tumbling granulator 1 will be described. The method for producing a granulated powder using the tumbling granulator 1 is one example of the method for producing a granulated powder according to the invention, and it is a matter of course that the method for producing a granulated powder according to the invention is not limited thereto.

Subsequently, the method for producing a granulated powder will be described.

The method for producing a granulated powder according to this embodiment includes allowing metal particles to tumble and/or flow while supplying a solution of an organic binder (a binder solution), thereby granulating the metal particles.

First, a metal powder is fed in the inside of the treatment vessel 10 of the tumbling granulator 1 as described above. Then, by stirring the metal powder with the blade 20, the metal powder is allowed to tumble and/or flow.

Concurrently with this, the binder solution is sprayed from the spray nozzle 40. The binder solution in the mist form wets the metal powder and also binds the metal particles of the metal powder. As a result, the metal powder is granulated, whereby a granulated powder 80 is obtained. This granulated powder 80 gradually moves (tumbles) toward the outer periphery (toward the side wall portion 12) of the treatment vessel 10 as the blade 20 rotates and also is thrown up above by the rotary vanes 21. The picked-up granulated powder 80 falls at the center of the treatment vessel 10 and is allowed to tumble again by the blade 20. When a series of processes as described above is repeated, the granulated powder is properly shaped, whereby the granulated power 80 having a shape close to a true sphere is formed. Accordingly, a dense granulated powder in which the distance between the comprised metal particles is short can be obtained.

Further, in such a granulation process, when the particles during granulation come in contact with the rotating cross screw 30, particles having a large particle diameter (particles in which the degree of granulation progress is high) are crushed. By doing this, excessive granulation is prevented, and the particle size distribution of the granulated powder is controlled to be narrow.

The binder solution may be supplied by any method, for example, by placing the binder solution in the treatment vessel 10 in advance, etc., however, it is preferred that the binder solution is sprayed from the top as shown in FIG. 1A. By doing this, the right amount of the binder solution is supplied uniformly to the granulated powder 80 picked-up by the blade 20, and therefore, the shape and size of the granulated powder 80 can be made uniform. In particular, by allowing the granulated powder 80 to come in contact with the binder solution while floating in the air, the entire surface of the particles of the granulated powder 80 is wetted uniformly, and therefore, the uniformity becomes more prominent. As a result, a granulated powder 80 having a uniform particle size distribution can be obtained.

Examples of the solvent to be used in the binder solution include inorganic solvents such as water, carbon disulfide, and carbon tetrachloride; and organic solvents including ketone-based solvents such as methyl ethyl ketone (MEK), acetone, diethyl ketone, methyl isobutyl ketone (MIBK), methyl isopropyl ketone (MIPK), cyclohexanone, 3-heptanone, and 4-heptanone; alcohol-based solvents such as methanol, ethanol, n-propanol, isopropanol, n-butanol, i-butanol, t-butanol, 3-methyl-1-butanol, 1-pentanol, 2-pentanol, n-hexanol, cyclohexanol, 1-heptanol, 1-octanol, 2-octanol, 2-methoxyethanol, allyl alcohol, furfuryl alcohol, and phenol; ether-based solvents such as diethyl ether, dipropyl ether, diisopropyl ether, dibutyl ether, 1,2-dimethoxyethane (DME), 1,4-dioxane, tetrahydrofuran (THF), tetrahydropyran (THP), anisole, diethylene glycol dimethyl ether (diglyme), and 2-methoxyethanol; cellosolve-based solvents such as methyl cellosolve, ethyl cellosolve, and phenyl cellosolve; aliphatic hydrocarbon-based solvents such as hexane, pentane, heptane, cyclohexane, methyl cyclohexane, octane, didecane, methylcyclohexene, and isoprene; aromatic hydrocarbon-based solvents such as toluene, xylene, benzene, ethylbenzene, and naphthalene; aromatic heterocyclic compound-based solvents such as pyridine, pyrazine, furan, pyrrole, thiophene, 2-methylpyridine, 3-methylpyridine, 4-methylpyridine, and furfuryl alcohol; amide-based solvents such as N,N-dimethylformamide (DMF) and N,N-dimethylacetoamide (DMA); halogen compound-based solvents such as dichloromethane, chloroform, 1,2-dichloroethane, trichloroethylene, and chlorobenzene; ester-based solvents such as acetylacetone, ethyl acetate, methyl acetate, isopropyl acetate, isobutyl acetate, isopentyl acetate, ethyl chloroaceate, butyl chloroacetate, isobutyl chloroacetate, ethyl formate, isobutyl formate, ethyl acrylate, methyl methacrylate, and ethyl benzoate; amine-based solvents such as trimethylamine, hexylamine, triethylamine, and aniline; nitrile-based solvents such as acrylonitrile and acetonitrile; nitro-based solvents such as nitromethane and nitroethane; and aldehyde-based solvents such as acetoaldehyde, propione aldehyde, butyl aldehyde, pentanal, and acrylaldehyde. These can be used alone or in admixture of two or more.

The number of rotations per unit time (hereinafter simply referred to as “rotation speed”) of the blade 20 is not particularly limited as long as it can ensure at least tumbling of the granulated powder 80. However, for example, it is preferably from about 50 to 500 rpm, more preferably from about 100 to 300 rpm. When the rotation speed of the blade 20 falls within the above range, the granulated powder 80 can be allowed to efficiently tumble and granulation can be efficiently performed. Further, a moderately consolidated state is obtained, and therefore, a granulated powder having a higher apparent density can be obtained. As a result, the granulated powder 80 which is denser and has a particularly narrow particle size distribution can be obtained.

On the other hand, if the rotation speed of the blade 20 is less than the above lower limit, tumbling or picking-up of the granulated powder 80 is insufficient, which may cause uneven granulation. Further, consolidation may be insufficient and a granulated powder 80 having a low apparent density may be formed, and also the granulated powder 80 which has not a spherical shape but an irregular shape with low fluidity may be formed. On the other hand, if the rotation speed of the blade 20 exceeds the above upper limit, the granulated particles may be crushed more than necessary by the blade 20.

Further, the number of rotations per unit time of the cross screw 30 at the time of granulation is not particularly limited, however, it is preferably from about 50 to 3500 rpm, more preferably from about 100 to 3000 rpm. According to this configuration, particles having a large particle diameter can be crushed while preventing excessive crushing of the particles so that the particle diameter can be made uniform.

Further, the supply rate of the binder solution is not particularly limited, however, for example, it is preferred from 20 to 1000 g/min, more preferably from 30 to 800 g/min, furthermore preferably from 50 to 600 g/min. When the supply rate of the binder solution falls within the above range, binding (granulation) of the metal powder by the binder solution is uniformly performed and the particle size distribution of the resulting granulated powder can be made sharper.

However, if the supply rate of the binder solution is less than the above lower limit, uneven granulation may be caused. On the other hand, if the supply rate of the binder solution exceeds the above upper limit, the granulation may proceed excessively. As a result, the resulting granulated powder may have a wide particle size distribution.

Further, the concentration of the organic binder in the binder solution is preferably from 0.5 to 20% by weight, more preferably from 1 to 15% by weight, further more preferably from 2 to 10% by weight.

The treatment time (stirring time) for granulation is not particularly limited, however, it is preferably from 1 to 90 minutes, more preferably from 2 to 85 minutes, further more preferably from 3 to 80 minutes. According to this configuration, ungranulated metal powder can be prevented from remaining, and the particle size distribution of the resulting granulated powder can be made sufficiently sharp. However, if the treatment time for granulation is less than the above lower limit, a relatively large amount of a powder having a small particle diameter (ungranulated metal powder, etc.) may remain. On the other hand, if the treatment time for granulation exceeds the above upper limit, a solvent may be directly applied to a powder having a relatively large particle diameter (a lump of a powder which does not tumble or flow) to cause uneven granulation.

Further, a solvent which can dissolve the organic binder may be sprayed (supplied) to the granulated powder as needed. According to this configuration, the granulated powder having a more uniform shape and size can be formed.

The granulated powder can be formed as described above.

A technique selected from a tumbling granulation method, a fluidized bed granulation method, and a tumbling fluidized bed granulation method, (all of which are examples of the granulation method described in the above) maybe used. However, the granulation method is not limited to these, and a spray drying method or the like can also be used.

Further, the use of the granulated powder according to the invention is not particularly limited. However, it can be preferably used in, for example, the production of a green body containing the granulated powder, particularly the production of a sintered body obtained by sintering the green body containing the granulated powder.

### Method for Producing Sintered Body

Hereinafter, one example of the method for producing a sintered body will be described.

### Molding

First, the granulated powder according to the invention as described above is molded using a press compacting machine, whereby a green body having a desired shape and dimension is produced. The granulated powder according to the invention itself is dense and has a high filling property. Therefore, a green body having a high density can be produced, and a sintered body having a high density and a low shrinkage ratio can be obtained in the end.

The shape and dimension of the green body to be produced are determined in expectation of a shrinkage due to the subsequent degreasing and sintering treatments. Further, the molding method is not limited to press compacting, and compression molding, injection molding, or the like may be employed.

### Degreasing Treatment

The green body obtained in the above-mentioned molding step is subjected to a degreasing treatment (binder removal treatment), whereby a degreased body is obtained. The degreasing treatment is not particularly limited, however, it can be performed by a heat treatment in a non-oxidative atmosphere, for example, under vacuum or a reduced pressure (for example, 1×10⁻¹ to 1×10⁻⁶ Torr), or in a gas such as nitrogen, argon, hydrogen, or dissociated ammonia. In this case, the condition for the heat treatment slightly varies depending on the decomposition initiation temperature of the organic binder or the like, however, the heat treatment is preferably performed at a temperature of about 100° C. to 750° C. for about 0.5 to 40 hours, more preferably performed at a temperature of about 150° C. to 700° C. for about 1 to 24 hours.

Further, the degreasing by such a heat treatment may be performed by being divided into a plurality of steps (stages) for various purposes (for example, for the purpose of reducing the degreasing time, etc.). In this case, for example, a method in which degreasing is performed at a low temperature in the former half and at a high temperature in the latter half, a method in which degreasing at a low temperature and degreasing at a high temperature are alternately repeated, or the like can be used.

Incidentally, it is not necessary to completely remove the organic binder by the degreasing treatment, and for example, a part thereof may remain at the time of completion of the degreasing treatment.

### Firing

The degreased body obtained in the above-mentioned degreasing treatment is fired in a firing furnace to effect sintering, whereby a desired sintered body is obtained. By this firing, the metal powder constituting the granulated powder is dispersed to cause grain growth, and a sintered body which is dense as a whole, in other words, has a high density and a low porosity can be obtained.

The firing temperature at the time of firing may vary depending on e.g. the composition of the granulated powder. However, for example, in the case of using an Fe-based alloy powder, the firing temperature is preferably 900° C. or higher but lower than 1200° C., more preferably from 1000° C. to 1170° C. When the firing temperature falls within the above range, a sintered body can be efficiently produced using a firing furnace which does not have a special heat resistant structure, is relatively inexpensive, and has low running cost. Incidentally, if the firing temperature is lower than the above lower limit, sintering of the metal powder may not sufficiently proceed, and the porosity of a finally obtained sintered body may be increased, and therefore, a sufficient mechanical strength may not be obtained. On the other hand, if the firing temperature exceeds the above upper limit, a firing furnace which has a special heat resistant structure is needed, and therefore, ease of firing is reduced.

The firing time (i.e. the time for which the maximum firing temperature is hold during firing) is preferably from about 0.5 to 8 hours, more preferably from about 0. 75 to 5 hours.

The firing atmosphere is not particularly limited. However, a reduced pressure (vacuum) atmosphere or a non-oxidative atmosphere is preferred. According to this configuration, deterioration of properties due to metal oxidation can be prevented. A preferred firing atmosphere is a reduced pressure (vacuum) atmosphere at 1 Torr or less (more preferably at 1×10² to 1×10⁶ Torr), an inert gas atmosphere of nitrogen, argon, or the like at 1 to 760 Torr, or a hydrogen gas atmosphere at 1 to 760 Torr.

The firing atmosphere may be changed in the course of firing. For example, the initial firing atmosphere is set to a reduced pressure (vacuum) atmosphere at 1×10⁻² to 1×10⁻⁶ Torr, which can be changed to an inert gas atmosphere as described above in the course of firing.

Further, the firing may be performed in two or more stages. For example, first firing and second firing, in which the firing conditions are different such that the firing temperature in the second firing is set to higher than that in the first firing, may be performed.

The thus obtained sintered body may be used for any purpose, e.g. as various machine parts.

The relative density of the thus obtained sintered body varies depending on e.g. the use thereof. However, for example, it is expected to be more than 93%, preferably 94% or more. Such a sintered body has a particularly excellent mechanical property. Further, by using the granulated powder according to the invention, even if it is fired at a low temperature, such a sintered body having an excellent mechanical property can be efficiently produced.

Hereinabove, the invention is described based on preferred embodiments, however, the invention is not limited to these.

For example, in the method for producing a granulated powder, an additional step can be added as needed.

Further, the device to be used in the method for producing a granulated powder according to the invention is not limited to one described in the above embodiment. For example, in the above embodiment, the case where a tumbling granulator is used is described, however, a fluidized bed granulator which performs granulation by means of a fluidizing action, a tumbling fluidized bed granulator which performs granulation by means of a tumbling and fluidizing action, a spray drying apparatus which performs spray drying, or the like may be used.

### EXAMPLES

### 1. Production of Granulated Powder

### Example 1

1) First, as a starting material powder, a 2% Ni—Fe alloy powder (true density: 7.827 g/cm³, manufactured by Epson Atmix Corporation) having an average particle diameter of 6 μm produced by a water atomization method was prepared. The composition of the 2% Ni—Fe is as follows: C: 0.4 to 0.6% by mass, Si: 0.35% by mass or less, Mn: 0.8% by mass or less, P: 0.03% by mass or less, S: 0.045% by mass or less, Ni: 1.5 to 2.5% by mass, Cr: 0.2% by mass or less, and Fe: remainder.

2) As an organic binder, polyvinyl alcohol, montan wax, and a sorbitan fatty acid ester were prepared. As a solvent, ion exchanged water was prepared. The amounts of the respective components of the organic binder, i.e., polyvinyl alcohol, montan wax, and a sorbitan fatty acid ester were set to 0.8 parts by weight, 0.04 parts by weight, and 0.01 parts by weight based on 100 parts by weight of the metal powder, respectively. The amount of solvent was set to 50 g per gram of the organic binder.

The resulting mixture was cooled to room temperature, whereby a binder solution was prepared.

3) Subsequently, the starting material powder was placed in a treatment vessel of a tumbling granulator (VG-25, manufactured by Powrex Corporation). Then, the starting material powder was allowed to tumble under the following condition set out below while spraying the binder solution from a spray nozzle of the tumbling granulator. By doing this, a granulated powder having an average particle diameter of 75 μm was obtained.

### Tumbling Condition

Rotation speed of blade: 200 rpm

Rotation speed of cross screw: 2500 rpm

Supply rate of binder solution: 200 g/min

Granulation time: 90 min

### Examples 2 to 9

Granulated powders were obtained in the same manner as in Example 1 except that the compositions and the amounts of the wax and the nonionic surfactant were changed as shown in Table 1, respectively.

### Examples 10 to 12

Granulated powders were obtained in the same manner as in Example 1 except that the amounts of the wax and the nonionic surfactant were changed as shown in Table 1, and an organic amine shown in Table 1 was added to the organic binder, respectively.

### Example 13

A granulated powder was obtained in the same manner as in Example 1 except that the amounts of the wax and the nonionic surfactant were changed as shown in Table 1, and a 2% Ni—Fe alloy powder having an average particle diameter of 6 μm and covered with a coating layer made of an organic amine was used as the starting material powder.

### Example 14

A granulated powder was obtained in the same manner as in Example 1 except that the amounts of the wax and the nonionic surfactant were changed as shown in Table 1, and the composition of the metal powder was changed to SUS-316L (true density: 7.98 g/cm³).

### Examples 15 to 28

Granulated powders were obtained in the same manner as in Examples 1 to 14, respectively, except that glycerin was added in an amount shown in Table 2 was added to each of the organic binders in Examples 1 to 14.

### Example 29 to 36

Granulated powders were obtained in the same manner as in Example 10 except that the amounts of the nonionic surfactant and the organic amine were changed as shown in Table 3, respectively.

### Comparative Examples 1 to 3

Granulated powders were obtained in the same manner as in Example 1 except that the organic binder was prepared using only polyvinyl alcohol (the addition of the wax and the nonionic surfactant was omitted) and the amount thereof was changed as shown in Table 1, respectively.

### Comparative Example 4

A granulated powder was obtained in the same manner as in Comparative Example 1 except that polyvinylpyrrolidone was used in place of polyvinyl alcohol.

### Comparative Example 5

A granulated powder was obtained in the same manner as in Comparative Example 1 except that montan wax (as the wax) was further added to the organic binder.

### Comparative Example 6

A granulated powder was obtained in the same manner as in Comparative Example 1 except that a sorbitan fatty acid ester (as the nonionic surfactant) was further added to the organic binder.

### Comparative Example 7

A granulated powder was obtained in the same manner as in Example 14 except that the organic binder was prepared using only polyvinyl alcohol (the addition of the wax and the nonionic surfactant was omitted) and the amount thereof was set as shown in Table 1.

### 2. Evaluation of Granulated Powder

### 2.1 Evaluation for Apparent Density

The apparent density of each of the granulated powders obtained in the respective Examples and Comparative Examples was measured. Then, the ratio thereof to the true density of each metal powder was calculated.

### 2.2 Evaluation for Molding Density

Each of the granulated powders obtained in the respective Examples and Comparative Examples was molded under the following molding condition.

### Molding Condition

Molding method: press compacting method

Molding shape: cube with a side of 20 mm

Compacting pressure: 600 MPa (6 t/cm2)

Subsequently, the dimension and weight of the obtained molded body (green body) were measured, and the molding density was calculated from the measurements.

### 2.3 Evaluation for Sintering Density

Subsequently, the obtained molded body (green body) was degreased under the following degreasing condition.

### Degreasing Condition

Degreasing temperature: 600° C.

Degreasing time: 1 hour

Degreasing atmosphere: hydrogen gas atmosphere

Subsequently, the obtained degreased body was fired under the following firing condition, whereby a sintered body was obtained.

### Firing Condition

Firing temperature: 1150° C.

Firing time: 3 hours

Firing atmosphere: reduced pressure Ar atmosphere

Atmospheric pressure: 1.3 kPa (10 Torr)

Subsequently, the density of the obtained sintered body was measured by a method according to the Archimedes method specified in JIS Z 2501. Further, the relative density of the sintered body was calculated from the measured sintering density and the true density of the metal powder.

### 2.4 Evaluation for Dimensional Accuracy

Subsequently, the width dimension of the obtained sintered body was measured using a micrometer. Then, evaluation was performed for the measurements according to the following evaluation criteria based on the “Permissible Deviations in Widths Without Tolerance” specified in JIS B 0411 (Permissible Deviations in Dimensions Without Tolerance Indication for Metallic Sintered Products).

Incidentally, the width of the sintered body refers to a dimension in the direction orthogonal to the direction of compression at the time of press compacting.

### Evaluation Criteria

A: Grade is fine (tolerance is ±0.1 mm or less)

B: Grade is medium (tolerance exceeds ±0.1 mm but is ±0.2 mm or less)

C: Grade is coarse (tolerance exceeds ±0.2 mm but is ±0.5 mm or less)

D: Outside the permissible tolerance

Hereinafter, the results of the evaluation items described in 2.1 to 2.4 are shown in Tables 1 to 3.

TABLE 1

| | | Organic binder | | | | | | | |
|---|---|---|---|---|---|---|---|---|---|
| | Metal | Polyvinyl alcohol | | Wax | | Nonionic surfactant | | Polyol | |
| | powder | | Parts | | Parts | | Parts | | Parts |
| | 100 parts | | by | | by | | by | | by |
| | by weight | Composition | weight | Composition | weight | Composition | weight | Composition | weight |
| Example 1 | 2% Ni—Fe | PVA | 0.8 | Montan wax | 0.04 | Sorbitan | 0.01 | — | — |
| | | | | | | fatty acid | | | |
| | | | | | | ester | | | |
| Example 2 | 2% Ni—Fe | PVA | 0.8 | Montan wax | 0.07 | Sorbitan | 0.03 | — | — |
| | | | | | | fatty acid | | | |
| | | | | | | ester | | | |
| Example 3 | 2% Ni—Fe | PVA | 0.8 | Montan wax | 0.14 | Sorbitan | 0.06 | — | — |
| | | | | | | fatty acid | | | |
| | | | | | | ester | | | |
| Example 4 | 2% Ni—Fe | PVA | 0.8 | Montan wax | 0.18 | Sorbitan | 0.12 | — | — |
| | | | | | | fatty acid | | | |
| | | | | | | ester | | | |
| Example 5 | 2% Ni—Fe | PVA | 0.8 | Montan wax | 0.31 | Sorbitan | 0.19 | — | — |
| | | | | | | fatty acid | | | |
| | | | | | | ester | | | |
| Example 6 | 2% Ni—Fe | PVA | 0.8 | Montan wax | 0.69 | Sorbitan | 0.31 | — | — |
| | | | | | | fatty acid | | | |
| | | | | | | ester | | | |
| Example 7 | 2% Ni—Fe | PVA | 0.8 | Paraffin wax | 0.05 | Sorbitan | 0.02 | — | — |
| | | | | | | fatty acid | | | |
| | | | | | | ester | | | |
| Example 8 | 2% Ni—Fe | PVA | 0.8 | Microcrystalline | 0.08 | Sorbitan | 0.02 | — | — |
| | | | | wax | | fatty acid | | | |
| | | | | | | ester | | | |
| Example 9 | 2% Ni—Fe | PVA | 0.8 | Montan wax | 0.08 | Glycerin fatty | 0.02 | — | — |
| | | | | | | acid ester | | | |
| Example 10 | 2% Ni—Fe | PVA | 0.8 | Montan wax | 0.08 | Sorbitan | 0.02 | — | — |
| | | | | | | fatty acid | | | |
| | | | | | | ester | | | |
| Example 11 | 2% Ni—Fe | PVA | 0.8 | Montan wax | 0.08 | Sorbitan | 0.02 | — | — |
| | | | | | | fatty acid | | | |
| | | | | | | ester | | | |
| Example 12 | 2% Ni—Fe | PVA | 0.8 | Montan wax | 0.08 | Sorbitan | 0.02 | — | — |
| | | | | | | fatty acid | | | |
| | | | | | | ester | | | |
| Example 13 | 2% Ni—Fe | PVA | 0.8 | Montan wax | 0.08 | Sorbitan | 0.02 | — | — |
| | | | | | | fatty acid | | | |
| | | | | | | ester | | | |
| Example 14 | SUS-316L | PVA | 0.8 | Montan wax | 0.08 | Sorbitan | 0.02 | — | — |
| | | | | | | fatty acid | | | |
| | | | | | | ester | | | |
| Comparative | 2% Ni—Fe | PVA | 0.8 | — | — | — | — | — | — |
| Example 1 | | | | | | | | | |
| Comparative | 2% Ni—Fe | PVA | 0.4 | — | — | — | — | — | — |
| Example 2 | | | | | | | | | |
| Comparative | 2% Ni—Fe | PVA | 3.5 | — | — | — | — | — | — |
| Example 3 | | | | | | | | | |
| Comparative | 2% Ni—Fe | PVP | 0.8 | — | — | — | — | — | — |
| Example 4 | | | | | | | | | |
| Comparative | 2% Ni—Fe | PVA | 0.8 | Montan wax | 0.12 | — | — | — | — |
| Example 5 | | | | | | | | | |
| Comparative | 2% Ni—Fe | PVA | 0.8 | — | — | Sorbitan | 0.02 | — | — |
| Example 6 | | | | | | fatty acid | | | |
| | | | | | | ester | | | |
| Comparative | SUS-316L | PVA | 0.8 | — | — | — | — | — | — |
| Example 7 | | | | | | | | | |

| | Organic binder | | Evaluation results | | | | |
|---|---|---|---|---|---|---|---|
| | Organic amine | | Ratio of apparent | | | | |
| | | Parts | density to true | Molding | Sintering | Relative | Dimensional |
| | | by | density | density | density | density | accuracy |
| | Composition | weight | % | g/cm³ | g/cm³ | % | — |
| Example 1 | — | — | 30.1 | 6.480 | 7.43 | 94.9 | B |
| Example 2 | — | — | 35.4 | 6.520 | 7.48 | 95.6 | A |
| Example 3 | — | — | 34.8 | 6.515 | 7.47 | 95.4 | A |
| Example 4 | — | — | 34.7 | 6.510 | 7.47 | 95.4 | A |
| Example 5 | — | — | 29.8 | 6.470 | 7.42 | 94.8 | B |
| Example 6 | — | — | 29.5 | 6.460 | 7.41 | 94.7 | B |
| Example 7 | — | — | 34.5 | 6.510 | 7.47 | 95.4 | A |
| Example 8 | — | — | 34.2 | 6.505 | 7.46 | 95.3 | A |
| Example 9 | — | — | 30.3 | 6.485 | 7.44 | 95.1 | A |
| Example 10 | Alkylamine | 0.1 | 36.7 | 6.636 | 7.49 | 95.7 | A |
| | derivative | | | | | | |
| Example 11 | Cycloalkylamine | 0.1 | 36.1 | 6.525 | 7.49 | 95.6 | A |
| | derivative | | | | | | |
| Example 12 | Alkanolamine | 0.1 | 35.6 | 6.520 | 7.48 | 95.6 | A |
| | derivative | | | | | | |
| Example 13 | Coating layer | — | 37.2 | 6.530 | 7.48 | 95.6 | A |
| | (alkylamine | | | | | | |
| | derivative) | | | | | | |
| Example 14 | | | 31.5 | — | 7.78 | 97.5 | A |
| Comparative | — | — | 17.2 | 6.450 | 7.40 | 94.5 | C |
| Example 1 | | | | | | | |
| Comparative | — | — | 54.1 | 6.470 | 6.95 | 88.8 | D |
| Example 2 | | | | | | | |
| Comparative | — | — | 18.2 | 6.140 | 6.54 | 83.6 | D |
| Example 3 | | | | | | | |
| Comparative | — | — | 16.3 | 6.270 | 7.10 | 90.7 | D |
| Example 4 | | | | | | | |
| Comparative | — | — | 15.2 | 6.410 | 7.35 | 93.9 | D |
| Example 5 | | | | | | | |
| Comparative | — | — | 19.6 | 6.450 | 7.40 | 94.5 | D |
| Example 6 | | | | | | | |
| Comparative | — | — | 18.7 | — | 7.45 | 93.4 | C |
| Example 7 | | | | | | | |

As is apparent from Table 1, it was confirmed that each of the molded bodies (green bodies) and the sintered bodies obtained using the granulated powders obtained in the respective Examples has a high density. In particular, it was revealed that the molding density and the sintering density can be specifically increased by using montan wax as the wax, using a sorbitan fatty acid ester as the nonionic surfactant, optimizing the total content of the wax and the nonionic surfactant, adding an organic amine, and so on.

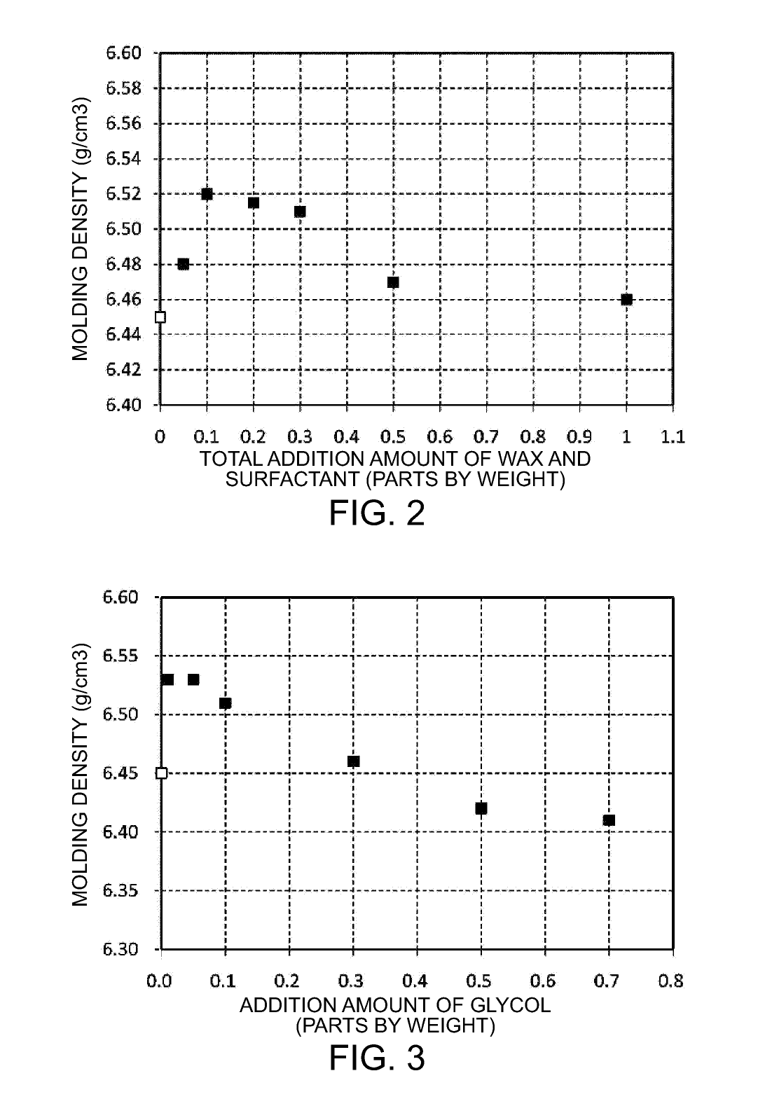

FIG. 2 is a graph showing the distribution of the molded bodies (green bodies) obtained using the granulated powders obtained in the respective Examples and Comparative Example 1 with the horizontal axis representing the total addition amount of the wax and the nonionic surfactant, and the vertical axis representing a molding density. Incidentally, in the graph, the respective Examples are indicated by black squares, and Comparative Example 1 is indicated by a white square.

From FIG. 2, it was confirmed that the molding density can be particularly increased when the total addition amount of the wax and the nonionic surfactant falls within a range from 0.01 to 1 part by weight based on 100 parts by weight of the metal powder.

Further, it was also confirmed that the sintered bodies obtained using the granulated powders obtained in the respective Examples have excellent dimensional accuracy.

On the other hand, by using the granulated powder obtained in Comparative Example 1, a sintered body was obtained by changing the firing temperature from 1150° C. to 1250° C. The sintering density of the resulting sintered body was 7.41 g/cm³, which was equivalent to that of the sintered body obtained using the granulated powder obtained in Example 1. From this result, it was revealed that according to the invention, a granulated powder can be favorably sintered even at a relatively low temperature using a firing furnace which is widely used and inexpensive.

TABLE 2

| | | Organic binder | | | | | | | |
|---|---|---|---|---|---|---|---|---|---|
| | Metal | Polyvinyl alcohol | | Wax | | Nonionic surfactant | | Polyol | |
| | powder | | Parts | | Parts | | Parts | | Parts |
| | 100 parts | | by | | by | | by | | by |
| | by weight | Composition | weight | Composition | weight | Composition | weight | Composition | weight |
| Example 15 | 2% Ni—Fe | PVA | 0.8 | Montan wax | 0.08 | Sorbitan | 0.02 | Glycerin | 0.01 |
| | | | | | | fatty acid | | | |
| | | | | | | ester | | | |
| Example 16 | 2% Ni—Fe | PVA | 0.8 | Montan wax | 0.08 | Sorbitan | 0.02 | Glycerin | 0.05 |
| | | | | | | fatty acid | | | |
| | | | | | | ester | | | |
| Example 17 | 2% Ni—Fe | PVA | 0.8 | Montan wax | 0.08 | Sorbitan | 0.02 | Glycerin | 0.10 |
| | | | | | | fatty acid | | | |
| | | | | | | ester | | | |
| Example 18 | 2% Ni—Fe | PVA | 0.8 | Montan wax | 0.08 | Sorbitan | 0.02 | Glycerin | 0.30 |
| | | | | | | fatty acid | | | |
| | | | | | | ester | | | |
| Example 19 | 2% Ni—Fe | PVA | 0.8 | Montan wax | 0.08 | Sorbitan | 0.02 | Glycerin | 0.50 |
| | | | | | | fatty acid | | | |
| | | | | | | ester | | | |
| Example 20 | 2% Ni—Fe | PVA | 0.8 | Montan wax | 0.08 | Sorbitan | 0.02 | Glycerin | 0.70 |
| | | | | | | fatty acid | | | |
| | | | | | | ester | | | |
| Example 21 | 2% Ni—Fe | PVA | 0.8 | Paraffin wax | 0.08 | Sorbitan | 0.02 | Glycerin | 0.01 |
| | | | | | | fatty acid | | | |
| | | | | | | ester | | | |
| Example 22 | 2% Ni—Fe | PVA | 0.8 | Microcrystalline | 0.08 | Sorbitan | 0.02 | Glycerin | 0.05 |
| | | | | wax | | fatty acid | | | |
| | | | | | | ester | | | |
| Example 23 | 2% Ni—Fe | PVA | 0.8 | Montan wax | 0.08 | Glycerin fatty | 0.02 | Glycerin | 0.05 |
| | | | | | | acid ester | | | |
| Example 24 | 2% Ni—Fe | PVA | 0.8 | Montan wax | 0.08 | Sorbitan | 0.02 | Glycerin | 0.05 |
| | | | | | | fatty acid | | | |
| | | | | | | ester | | | |
| Example 25 | 2% Ni—Fe | PVA | 0.8 | Montan wax | 0.08 | Sorbitan | 0.02 | Glycerin | 0.05 |
| | | | | | | fatty acid | | | |
| | | | | | | ester | | | |
| Example 26 | 2% Ni—Fe | PVA | 0.8 | Montan wax | 0.08 | Sorbitan | 0.02 | Glycerin | 0.05 |
| | | | | | | fatty acid | | | |
| | | | | | | ester | | | |
| Example 27 | 2% Ni—Fe | PVA | 0.8 | Montan wax | 0.08 | Sorbitan | 0.02 | Glycerin | 0.05 |
| | | | | | | fatty acid | | | |
| | | | | | | ester | | | |
| Example 28 | SUS-316L | PVA | 0.8 | Montan wax | 0.08 | Sorbitan | 0.02 | Glycerin | 0.05 |
| | | | | | | fatty acid | | | |
| | | | | | | ester | | | |
| Comparative | 2% Ni—Fe | PVA | 0.8 | — | — | — | — | — | — |
| Example 1 | | | | | | | | | |
| Comparative | 2% Ni—Fe | PVA | 0.4 | — | — | — | — | — | — |
| Example 2 | | | | | | | | | |
| Comparative | 2% Ni—Fe | PVA | 3.5 | — | — | — | — | — | — |
| Example 3 | | | | | | | | | |
| Comparative | 2% Ni—Fe | PVP | 0.8 | — | — | — | — | — | — |
| Example 4 | | | | | | | | | |
| Comparative | 2% Ni—Fe | PVA | 0.8 | Montan wax | 0.12 | — | — | — | — |
| Example 5 | | | | | | | | | |
| Comparative | 2% Ni—Fe | PVA | 0.8 | — | — | Sorbitan | 0.02 | — | — |
| Example 6 | | | | | | fatty acid | | | |
| | | | | | | ester | | | |
| Comparative | SUS-316L | PVA | 0.8 | — | — | — | — | — | — |
| Example 7 | | | | | | | | | |

| | Organic binder | | Evaluation results | | | | |
|---|---|---|---|---|---|---|---|
| | Organic amine | | Ratio of apparent | | | | |
| | | Parts | density to true | Molding | Sintering | Relative | Dimensional |
| | | by | density | density | density | density | accuracy |
| | Composition | weight | % | g/cm³ | g/cm³ | % | — |
| Example 15 | — | — | 31.2 | 6.530 | 7.49 | 95.7 | A |
| Example 16 | — | — | 36.2 | 6.530 | 7.49 | 95.7 | A |
| Example 17 | — | — | 35.3 | 6.510 | 7.47 | 95.4 | A |
| Example 18 | — | — | 35.0 | 5.460 | 7.41 | 94.7 | B |
| Example 19 | — | — | 30.4 | 6.420 | 7.36 | 94.0 | B |
| Example 20 | — | — | 29.8 | 6.410 | 7.35 | 93.9 | B |
| Example 21 | — | — | 35.1 | 6.535 | 7.49 | 95.7 | A |
| Example 22 | — | — | 35.0 | 6.520 | 7.48 | 95.6 | A |
| Example 23 | — | — | 31.2 | 6.495 | 7.45 | 95.2 | A |
| Example 24 | Alkylamine | 0.1 | 37.1 | 6.575 | 7.54 | 96.3 | A |
| | derivative | | | | | | |
| Example 25 | Cycloalkylamine | 0.1 | 36.7 | 6.555 | 7.52 | 96.1 | A |
| | derivative | | | | | | |
| Example 26 | Alkanolamine | 0.1 | 36.2 | 6.540 | 7.50 | 95.8 | A |
| | derivative | | | | | | |
| Example 27 | Coating layer | — | 37.4 | 6.560 | 7.52 | 96.1 | A |
| | (alkylamine | | | | | | |
| | derivative) | | | | | | |
| Example 28 | | | 32.5 | — | 7.80 | 97.7 | A |
| Comparative | — | — | 17.2 | 6.450 | 7.40 | 94.5 | C |
| Example 1 | | | | | | | |
| Comparative | — | — | 54.1 | 6.470 | 6.95 | 88.8 | D |
| Example 2 | | | | | | | |
| Comparative | — | — | 18.2 | 6.140 | 6.54 | 83.6 | D |
| Example 3 | | | | | | | |
| Comparative | — | — | 16.3 | 6.270 | 7.10 | 90.7 | D |
| Example 4 | | | | | | | |
| Comparative | — | — | 15.2 | 6.410 | 7.35 | 93.9 | D |
| Example 5 | | | | | | | |
| Comparative | — | — | 19.6 | 6.450 | 7.40 | 94.5 | D |
| Example 6 | | | | | | | |
| Comparative | — | — | 18.7 | — | 7.45 | 93.4 | C |
| Example 7 | | | | | | | |

As is apparent from Table 2, it was confirmed that each of the molded bodies (green bodies) and the sintered bodies obtained using the granulated powders obtained in the respective Examples has a high density. In particular, it was confirmed that densification is further enhanced by adding glycerin to the organic binder in a given amount as compared with the case where glycerin is not added.

FIG. 3 is a graph showing the distribution of the molded bodies (green bodies) obtained using the granulated powders obtained in the respective Examples and Comparative Example 1 with the horizontal axis representing the addition amount of the polyol and the vertical axis representing the molding density. In the graph, the respective Examples are indicated by black squares, and Comparative Example 1 is indicated by a white square.

From FIG. 3, it was confirmed that the molding density can be particularly increased when the addition amount of the polyol falls within a range from 0.01 to 0.3 parts by weight based on 100 parts by weight of the metal powder.

Further, it was also confirmed that the sintered bodies obtained using the granulated powders obtained in the respective Examples have excellent dimensional accuracy.

Incidentally, molded bodies (green bodies) and sintered bodies were produced in the same manner using the granulated powders obtained in the same manner as in Examples 15 to 17, respectively, except that glycerin was changed to propylene glycol, and evaluated in the same manner. As a result, although the density was equivalent or decreased by about 2% to 5% as compared with the case of using the corresponding granulated powders of Examples 15 to 17, favorable evaluation results were obtained.

TABLE 3

| | | Organic binder | | | | | | | |
|---|---|---|---|---|---|---|---|---|---|
| | Metal | Polyvinyl alcohol | | Wax | | Nonionic surfactant | | Polyol | |
| | powder | | Parts | | Parts | | Parts | | Parts |
| | 100 parts | | by | | by | | by | | by |
| | by weight | Composition | weight | Composition | weight | Composition | weight | Composition | weight |
| Example 29 | 2% Ni—Fe | PVA | 0.8 | Montan wax | 0.08 | Sorbitan fatty | 0.03 | — | — |
| | | | | | | acid ester | | | |
| Example 30 | 2% Ni—Fe | PVA | 0.8 | Montan wax | 0.08 | Sorbitan fatty | 0.03 | — | — |
| | | | | | | acid ester | | | |
| Example 31 | 2% Ni—Fe | PVA | 0.8 | Montan wax | 0.08 | Sorbitan fatty | 0.03 | — | — |
| | | | | | | acid ester | | | |
| Example 32 | 2% Ni—Fe | PVA | 0.8 | Montan wax | 0.08 | Sorbitan fatty | 0.03 | — | — |
| | | | | | | acid ester | | | |
| Example 33 | 2% Ni—Fe | PVA | 0.8 | Montan wax | 0.08 | Sorbitan fatty | 0.03 | — | — |
| | | | | | | acid ester | | | |
| Example 34 | 2% Ni—Fe | PVA | 0.8 | Montan wax | 0.08 | Sorbitan fatty | 0.03 | — | — |
| | | | | | | acid ester | | | |
| Example 35 | 2% Ni—Fe | PVA | 0.8 | Montan wax | 0.08 | Sorbitan fatty | 0.03 | — | — |
| | | | | | | acid ester | | | |
| Example 36 | 2% Ni—Fe | PVA | 0.8 | Montan wax | 0.08 | Sorbitan fatty | 0.03 | — | — |
| | | | | | | acid ester | | | |
| Comparative | 2% Ni—Fe | PVA | 0.8 | — | — | — | — | — | — |
| Example 1 | | | | | | | | | |
| Comparative | 2% Ni—Fe | PVA | 0.4 | — | — | — | — | — | — |
| Example 2 | | | | | | | | | |
| Comparative | 2% Ni—Fe | PVA | 3.5 | — | — | — | — | — | — |
| Example 3 | | | | | | | | | |
| Comparative | 2% Ni—Fe | PVP | 0.8 | — | — | — | — | — | — |
| Example 4 | | | | | | | | | |
| Comparative | 2% Ni—Fe | PVA | 0.8 | Montan wax | 0.12 | — | — | — | — |
| Example 5 | | | | | | | | | |
| Comparative | 2% Ni—Fe | PVA | 0.8 | — | — | Sorbitan fatty | 0.02 | — | — |
| Example 6 | | | | | | acid ester | | | |
| Comparative | SUS-316L | PVA | 0.8 | — | — | — | — | — | — |
| Example 7 | | | | | | | | | |

| | Organic binder | | Evaluation results | | | | |
|---|---|---|---|---|---|---|---|
| | Organic amine | | Ratio of apparent | | | | |
| | | Parts | density to true | Molding | Sintering | Relative | Dimensional |
| | | by | density | density | density | density | accuracy |
| | Composition | weight | % | g/cm³ | g/cm³ | % | — |
| Example 29 | Alkylamine | 0.03 | 35.6 | 6.500 | 7.46 | 95.3 | B |
| | derivative | | | | | | |
| Example 30 | Alkylamine | 0.04 | 35.8 | 6.520 | 7.48 | 95.6 | A |
| | derivative | | | | | | |
| Example 31 | Alkylamine | 0.05 | 36.0 | 6.525 | 7.48 | 95.6 | A |
| | derivative | | | | | | |
| Example 32 | Alkylamine | 0.08 | 36.4 | 6.530 | 7.49 | 95.7 | A |
| | derivative | | | | | | |
| Example 33 | Alkylamine | 0.1 | 36.9 | 6.535 | 7.50 | 95.8 | A |
| | derivative | | | | | | |
| Example 34 | Alkylamine | 0.15 | 36.1 | 6.525 | 7.47 | 95.4 | A |
| | derivative | | | | | | |
| Example 35 | Alkylamine | 0.2 | 35.4 | 6.515 | 7.44 | 95.1 | A |
| | derivative | | | | | | |
| Example 36 | Alkylamine | 0.25 | 35.1 | 6.495 | 7.43 | 94.9 | B |
| | derivative | | | | | | |
| Comparative | — | — | 17.2 | 6.450 | 7.40 | 94.5 | C |
| Example 1 | | | | | | | |
| Comparative | — | — | 54.1 | 6.470 | 6.95 | 88.8 | D |
| Example 2 | | | | | | | |
| Comparative | — | — | 18.2 | 6.140 | 6.54 | 83.6 | D |
| Example 3 | | | | | | | |
| Comparative | — | — | 16.3 | 6.270 | 7.10 | 90.7 | D |
| Example 4 | | | | | | | |
| Comparative | — | — | 15.2 | 6.410 | 7.35 | 93.9 | D |
| Example 5 | | | | | | | |
| Comparative | — | — | 19.6 | 6.450 | 7.40 | 94.5 | D |
| Example 6 | | | | | | | |
| Comparative | — | — | 18.7 | — | 7.45 | 93.4 | C |
| Example 7 | | | | | | | |

As is apparent from Table 3, it was revealed that the molding density and the sintering density can be specifically increased by optimizing the addition amount of the organic amine to be added to the organic binder.

The entire disclosure of Japanese Patent Application No. 2010-055147, filed Mar. 11, 2010 is expressly incorporated by reference herein.

What is claimed is:

1. A granulated powder, comprising a plurality of metal particles bonded to one another by an organic binder, wherein the organic binder contains polyvinyl alcohol or a derivative thereof, a wax, and a nonionic surfactant.

2. The granulated powder according to claim 1, wherein a total amount of the wax and the nonionic surfactant is from 0.01 to 1 part by weight based on 100 parts by weight of the metal particles.

3. The granulated powder according to claim 1, wherein the wax is a mineral wax, a petroleum wax, or a modified wax thereof.

4. The granulated powder according to claim 3, wherein the mineral wax is montan wax or a derivative thereof.

5. The granulated powder according to claim 3, wherein the petroleum wax is paraffin wax, microcrystalline wax, or a derivative thereof.

6. The granulated powder according to claim 1, wherein the nonionic surfactant is a sorbitan fatty acid ester.

7. The granulated powder according to claim 1, wherein the organic binder further contains a polyol.

8. The granulated powder according to claim 7, wherein the polyol is glycerin.

9. The granulated powder according to claim 7, wherein an amount of the polyol is 0.01 parts by weight or more but less than 0.3 parts by weight based on 100 parts by weight of the metal particles.

10. The granulated powder according to claim 1, wherein the organic binder further contains an organic amine.

11. The granulated powder according to claim 10, wherein the organic amine is at least one of an alkylamine, a cycloalkylamine, an alkanolamine, and a derivative thereof.

12. The granulated powder according to claim 10, wherein an amount of the organic amine is from 30 to 200% by weight based on the total amount of the wax and the nonionic surfactant.

13. The granulated powder according to claim 10, wherein each of the plurality of the metal particles is covered with a coating layer comprises the organic amine.

14. A method for producing a granulated powder, comprising:
providing a metal powder;
while tumbling or flowing the metal powder, simultaneously supplying a solution of an organic binder to the metal powder,
wherein the organic binder contains:
polyvinyl alcohol, a wax, and a nonionic surfactant, thereby,
to granulate the metal powder.

15. The method for producing a granulated powder according to claim 14, wherein the solution of the organic binder is supplied by spraying.
